(19) United States
(12) Patent Application Publication
(10) Pub. No.: US 2013/0038577 A1
(43) Pub. Date: Feb. 14, 2013

(54) OPTICAL TOUCH DEVICE AND COORDINATE DETECTION METHOD THEREOF

(71) Applicants: Yu-Yen CHEN, New Taipei City (TW); Shih-Wen CHEN, New Taipei City (TW); Kou-Hsien LU, New Taipei City (TW)

(72) Inventors: Yu-Yen CHEN, New Taipei City (TW); Shih-Wen CHEN, New Taipei City (TW); Kou-Hsien LU, New Taipei City (TW)

(21) Appl. No.: 13/541,593

(22) Filed: Jul. 3, 2012

(30) Foreign Application Priority Data
Aug. 11, 2011 (TW) 100128782

(51) Int. Cl. G06F 3/042

(52) U.S. Cl. 345/175

(57) ABSTRACT

An optical touch device and a coordinate detection method thereof are disclosed. The optical touch device includes a detection area, a first capture module, a second capture module, and a processing module. The detection area provides a first object and a second object to contact with. The first capture module captures a first captured image from the detection area and captures a first object image and a second object image. The second capture module captures a second captured image from the detection area and captures a third object image and a fourth object image. The processing module calculates coordinates of a plurality of touch point according to the first captured image and the second captured image and determines the plurality of touch point is a real point or a ghost point according to the relation between the first object image to the fourth object image.

### BACKGROUND OF THE INVENTION

1. Field of the Invention

The present invention relates to an optical touch device and a coordinate detection method thereof; more particularly, the present invention relates to an optical touch device and a coordinate detection method thereof capable of determining whether a touch point is a real point or a ghost point.

2. Description of the Related Art

With the advance of technology, touch panels have been widely applied in our daily lives, such that users can manipulate electronic products in a more intuitive way. In known prior arts, the touch panels are usually resistive-type or capacitive-type structures. However, the resistive or capacitive touch panel is only applicable for a small-sized touch panel; the manufacturing cost would be significantly increased if it is applied in a large-sized touch panel.

Therefore, in known prior arts, an optical coordinate input device has been invented to solve the problem of high manufacturing cost of a large-sized resistive or capacitive touch panel. Please refer to FIG. 1A, which illustrates a schematic drawing of a conventional optical touch device having a single touch point according to a known prior art.

In FIG. 1A, the optical touch device 90 comprises a detection area 91, a first capture module 921, a second capture module 922 and a processing module 93. The detection area 91 is used for allowing an object 94 to contact with. If the object 94 is in the detection area 91, the first capture module 921 and the second capture module 922 respectively capture images of the object 94, and transmit the images to the processing module 93 for calculation. For example, if the detection area 91 has a width W and a height H, a first angle θ1 can be calculated according to the image of the object 94 captured by the first capture module 921, and a second angle θ2 can be calculated according to the image of the object 94 captured by the second capture module 922. Then, a trigonometric function can be used to calculate a coordinate point of the object 94 on a horizontal axis X:

$$X = \frac{W * tan θ2}{tan θ1 + tan θ2} ;$$

and to calculate a coordinate point of the object 94 on a vertical axis Y:

Y=X*tan θ1.

As a result, the processing module 93 can obtain the coordinate of the object 94 according to the images captured by the first capture module 921 and the second capture module 922.

However, the abovementioned method is only applicable for allowing a single object 94 to contact with the detection area 91. Next, please refer to FIG. 1B, which illustrates a schematic drawing of a conventional optical touch device having a plurality of touch points according to a known prior art.

If two objects 94 are in the detection area 91, the first capture module 921 and the second capture module 922 respectively capture images of the two objects 94. The processing module 93 would calculate four touch points according to the captured images. As shown in FIG. 1B, the four touch points include two real points 951 and two ghost points 952. If the processing module 93 fails to determine accurate positions of the real points 951 and the ghost points 952, it would cause chaos when manipulating the optical touch device 90. Or, it is also applicable for limiting the function of the optical touch device 90 in controlling only a single object 94, but this would restrict the function of the optical touch device 90.

Therefore, there is a need to provide an optical touch device and a coordinate detection method thereof capable of determining ghost points to mitigate and/or obviate the aforementioned problems.

### SUMMARY OF THE INVENTION

It is an object of the present invention to provide an optical touch device, which is capable of determining whether a touch point is a real point or a ghost point.

It is another object of the present invention to provide a coordinate detection method, which is capable of determining whether a touch point is a real point or a ghost point.

To achieve the abovementioned objects, the optical touch device of the present invention comprises a detection area, a first capture module, a second capture module and a processing module. The detection area is used for allowing a first object and a second object to contact with. The first capture module captures a first captured image from the detection area to capture a first object image and a second object image. The second capture module captures a second captured image from the detection area to capture a third object image and a fourth object image. The processing module is electrically connected to the first capture module and the second capture module. The processing module calculates coordinates of a plurality of touch points according to the first captured image and the second captured image, and determines whether each of the plurality of touch points is a real point or a ghost point according to the relations among the first object image, the second object image, the third object image and the fourth object image.

The coordinate detection method of the present invention is used in an optical touch device. The optical touch device comprises a detection area used for allowing a first object and a second object to contact with. The coordinate detection method comprises the following steps: capturing a first captured image from the detection area to capture a first object image and a second object image according to a first capture module; capturing a second captured image from the detection area to capture a third object image and a fourth object image according to a second capture module; calculating coordinates of a plurality of touch points according to the first captured image and the second captured image; and determining whether each of the plurality of touch points is a real point or a ghost point according to the relations among the first object image, the second object image, the third object image and the fourth object image.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A illustrates a schematic drawing of a conventional optical touch device having a single touch point according to a known prior art.

FIG. 1B illustrates a schematic drawing of a conventional optical touch device having a plurality of touch points according to a known prior art.

FIG. 2 illustrates a schematic drawing of an optical touch device according to one embodiment of the present invention.

FIG. 3 illustrates a flowchart of a coordinate detection method according to the present invention.

FIGS. 4A-4B illustrate flowcharts for determining whether a plurality of touch points are real points or ghost points according to a first embodiment of the present invention.

FIGS. 5A-5D illustrate schematic drawings of the optical touch device of the present invention in the first embodiment according to FIGS. 4A-4B.

FIG. 6 illustrates a flowchart for determining whether a plurality of touch points are real points or ghost points according to a second embodiment of the present invention.

FIGS. 7A-7B illustrate schematic drawings of the optical touch device of the present invention in the second embodiment according to FIG. 6.

FIG. 8 illustrates a flowchart for determining whether a plurality of touch points are real points or ghost points according to a third embodiment of the present invention.

FIGS. 9A-9B illustrate schematic drawings of the optical touch device of the present invention in the third embodiment according to FIG. 8.

FIG. 10 illustrates a flowchart for determining whether a plurality of touch points are real points or ghost points according to a fourth embodiment of the present invention.

FIGS. 11A-11B illustrate schematic drawings of the optical touch device of the present invention in the fourth embodiment according to FIG. 10.

FIG. 12 illustrates a flowchart for determining whether a plurality of touch points are real points or ghost points according to a fifth embodiment of the present invention.

FIG. 13 illustrates a schematic drawing of the optical touch device of the present invention in the fifth embodiment according to FIG. 12.

FIG. 14 illustrates a schematic drawing showing the optical touch device calculates a central angle degree according to the present invention.

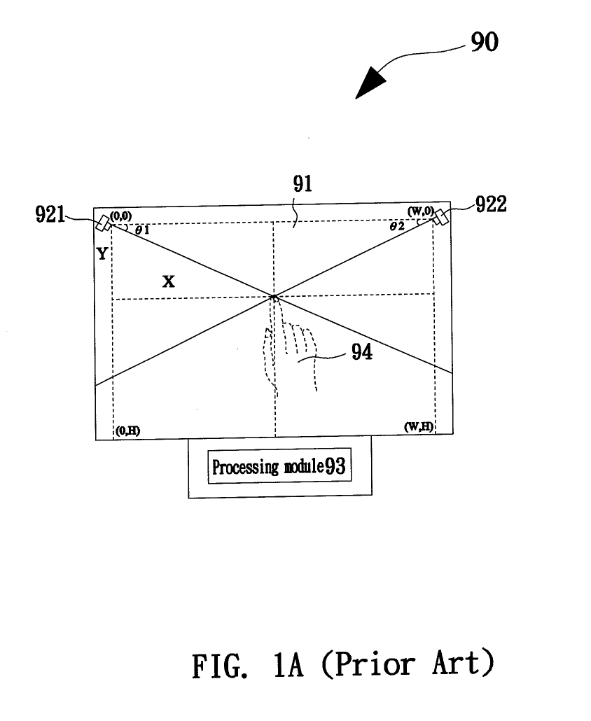

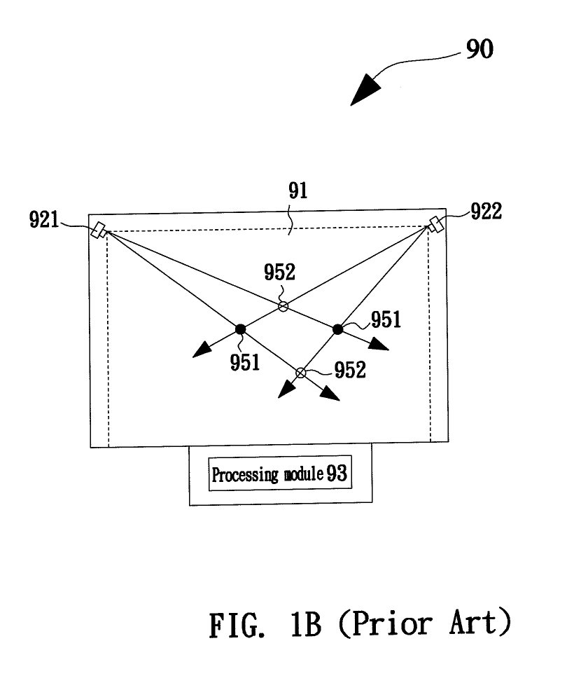

### DETAILED DESCRIPTION OF THE PREFERRED EMBODIMENT

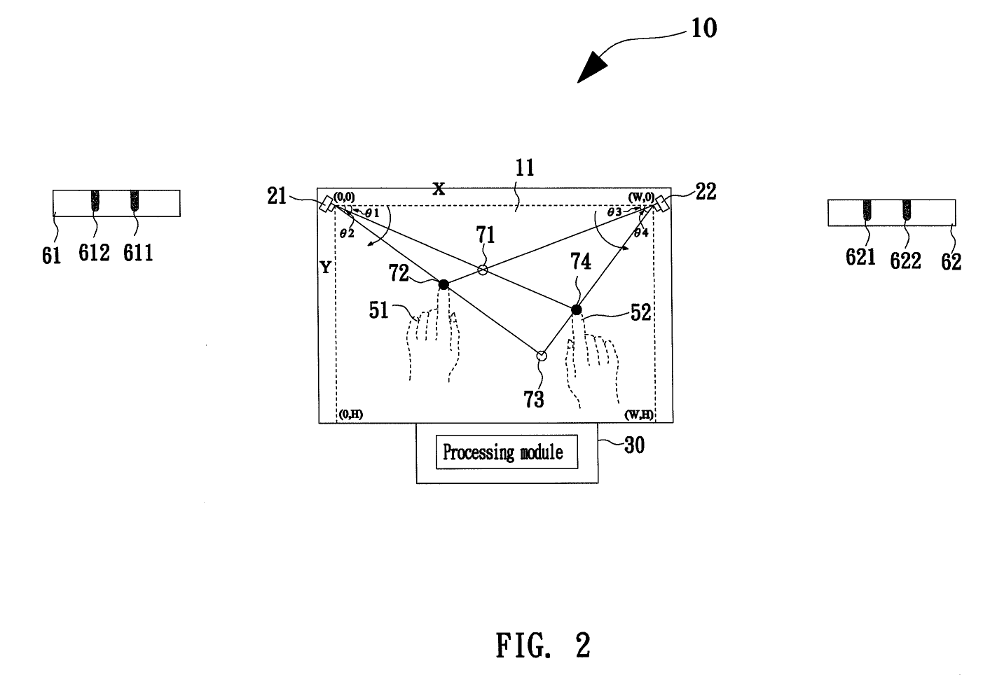

Please refer to FIG. 2, which illustrates a schematic drawing of an optical touch device according to one embodiment of the present invention.

The optical touch device 10 of the present invention can calculate a coordinate of an object when the object approaches or contacts. The object can be, but not limited to, a user's finger, a touch pen, a stylus or other contact object. In this embodiment, the object is the user's finger as a non-limiting example. In each of the embodiments of the present invention, the optical touch device 10 can detect the coordinates of a first object 51 and a second object 52 at the same time. The precise detection method will be described in more detail in later paragraphs, so currently there is no need for further description. The optical touch device 10 can be combined with an electronic device such as a display screen, so as to form a touch screen, but please note the scope of the present invention is not limited to the above description.

The optical touch device 10 comprises a detection area 11, a first capture module 21, a second capture module 22 and a processing module 30. The detection area 11 can be, but not limited to, an area above the display screen of the electronic device. The detection area 11 is used for allowing the first object 51 and the second object 52 to approach or contact with.

The first capture module 21 and the second capture module 22 can be, but not limited to, a charge-coupled device (CCD) or a complementary metal oxide semiconductor (CMOS). In one embodiment of the present invention, the first capture module 21 and the second capture module 22 are respectively disposed to adjacent corners of the detection area 11, such as the upper-right and upper-left corners, the upper-right and lower-right corners, the upper-left and lower-left corners or the lower-right and lower-left corners of the detection area 11, so as to directly capture images from the detection area 11. Please note that the optical touch device 10 of the present invention is not limited to comprise only two capture modules, more than two capture modules respectively disposed to different corners of the detection area 11 are also applicable.

The first capture module 21 captures from the detection area 11 so as to capture a first captured image 61. The second capture module 22 also captures from the detection area 11 so as to capture a second captured image 62. In this embodiment, because the detection area 11 is contacted by both the first object 51 and the second object 52 at the same time, the first captured image 61 would capture a first object image 611 and a second object image 612, and the second captured image 62 would capture a third object image 621 and a fourth object image 622.

The processing module 30 is electrically connected to the first capture module 21 and the second capture module 22, and is used for processing the images captured by the first capture module 21 and the second capture module 22, so as to calculate coordinates of a plurality of touch points by using a trigonometric function and related methods. For example, FIG. 2 shows a first touch point 71, a second touch point 72, a third touch point 73 and a fourth touch point 74, and the present invention can further determine whether each of the plurality of touch points is a real point or a ghost point according to the relations among the first object image 611, the second object image 612, the third object image 621 and the fourth object image 622. Because detection method of the processing module 30 will be described in more detail in later paragraphs, currently there is no need for further description about the method.

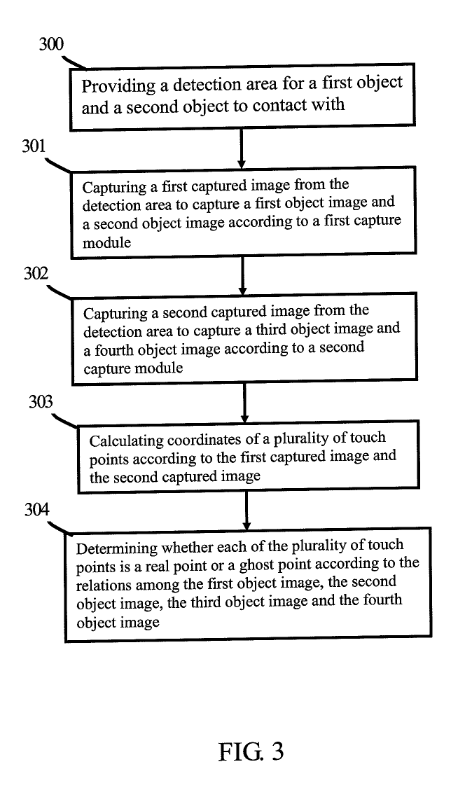

Then, please refer to FIG. 3, which illustrates a flowchart of a coordinate detection method according to the present invention. In the embodiment, the optical touch device 10 is used as an example to demonstrate the coordinate detection method of the present invention; however, please note that the coordinate detection method of the present invention is not limited to be used in the optical touch device 10 as described above.

Firstly, the method performs step 300: providing a detection area for a first object and a second object to contact with.

The optical touch device 10 provides the detection area 11, such that the first object 51 and the second object 52 can contact with or approach the detection area 11.

Then, the method performs step 301: capturing a first captured image from the detection area to capture a first object image and a second object image according to a first capture module.

The optical touch device 10 captures from the detection area 11 by the first capture module 21. Therefore, the first capture module 21 captures the first object image 611 and the second object image 612 from the detection area 11. The first object image 611 is located close to a horizontal axis X of the detection area 11 in the first captured image 61. The second object image 612 is located close to a vertical axis Y of the detection area 11 in the first captured image 61.

Meanwhile, the method performs step 302: capturing a second captured image from the detection area to capture a third object image and a fourth object image according to a second capture module.

Similarly, the optical touch device 10 captures from the detection area 11 by the second capture module 22. Therefore, the second capture module 22 captures the third object image 621 and the fourth object image 622 from the detection area 11. The third object image 621 is located close to the horizontal axis X of the detection area 11 in the second captured image 62. The fourth object image 622 is located close to the vertical axis Y of the detection area 11 in the second captured image 62.

Then, the method performs step 303: calculating coordinates of a plurality of touch points according to the first captured image and the second captured image.

The processing module 30 calculates the coordinates of a plurality of touch points according to the first captured image 61 and the second captured image 62.

When the first capture module 21 captures the first captured image 61, the processing module 30 performs calculation in the first captured image 61 from the side close to the horizontal axis X toward the side close to the vertical axis Y. As shown in FIG. 2, the processing module 30 firstly calculates a first captured angle θ1 according to the position of the first object image 611 in the first captured image 61, and then calculates a second captured angle θ2 according to the position of the second object image 612 in the first captured image 61. Likewise, when the second capture module 22 captures the second captured image 62, the processing module 30 also performs calculation in the second captured image 62 from the side close to the horizontal axis X toward the side close to the vertical axis Y. The processing module 30 firstly calculates a third captured angle θ3 according to the position of the third object image 621 in the second captured image 62, and then calculates a fourth captured angle θ4 according to the position of the fourth object image 622 in the second captured image 62. Therefore, according to the values of the first captured angle θ1, the second captured angle θ2, the third captured angle θ3 and the fourth captured angle θ4, the processing module 30 can use the trigonometric function and related methods to respectively calculate the coordinate including the width W in the horizontal axis X and the height H in the vertical axis Y of the first touch point 71, the second touch point 72, the third touch point 73 and the fourth touch point 74. Because the techniques of calculating the captured angle and the coordinate of each touch point are widely known by those skilled in the art, therefore there is no need for further description.

Finally, the method performs step 304: determining whether each of the plurality of touch points is a real point or a ghost point according to the relations among the first object image, the second object image, the third object image and the fourth object image.

Finally, according to the relations such as distances, luminance, sizes or widths among the first object image 611, the second object image 612, the third object image 621 and the fourth object image 622, the processing module 30 determines whether the abovementioned first touch point 71, the second touch point 72, the third touch point 73 and the fourth touch point 74 are the real points or the ghost points. The detailed embodiment of determining the real and ghost points will be described hereinafter.

Further, please note that in step 303, if the coordinate of any of the touch points exceeds the range of the detection area 11, the processing module 30 can directly determine this specific touch point as the ghost point. Further, because the calculation results of the touch points in step 303 is definitely paired, the touch point paired with this specific touch point must be determined as the ghost point as well. For example, as shown in FIG. 2, the first touch point 71 and the third touch point 73 is a pair, and the second touch point 72 and the fourth touch point 74 is another pair. Therefore, if the coordinate of the third touch point 73 exceeds the range of the detection area 11, not only the third touch point 73, but also its paired first touch point 71 would be determined as the ghost points. Accordingly, the remaining second touch point 72 and the fourth touch point 74 must be the real points. As a result, no further determination process needs to be executed.

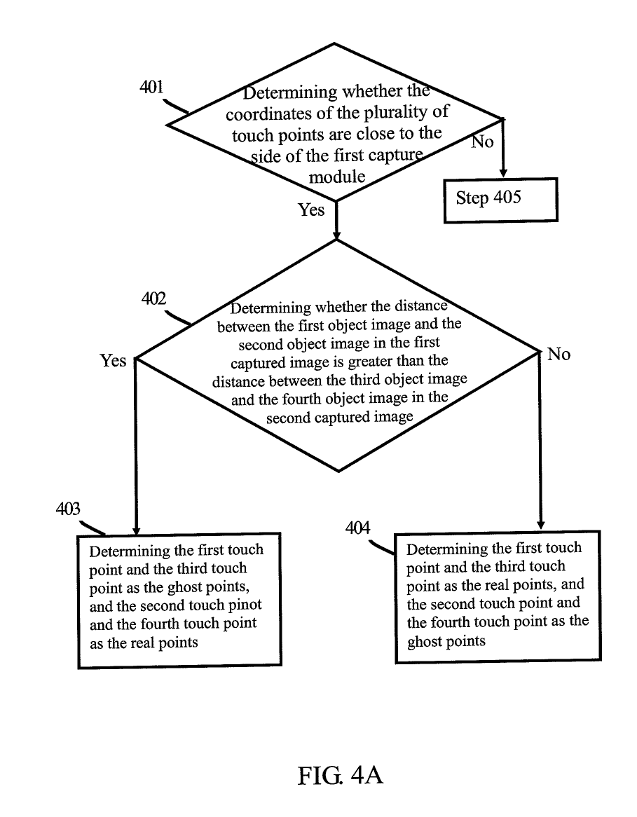

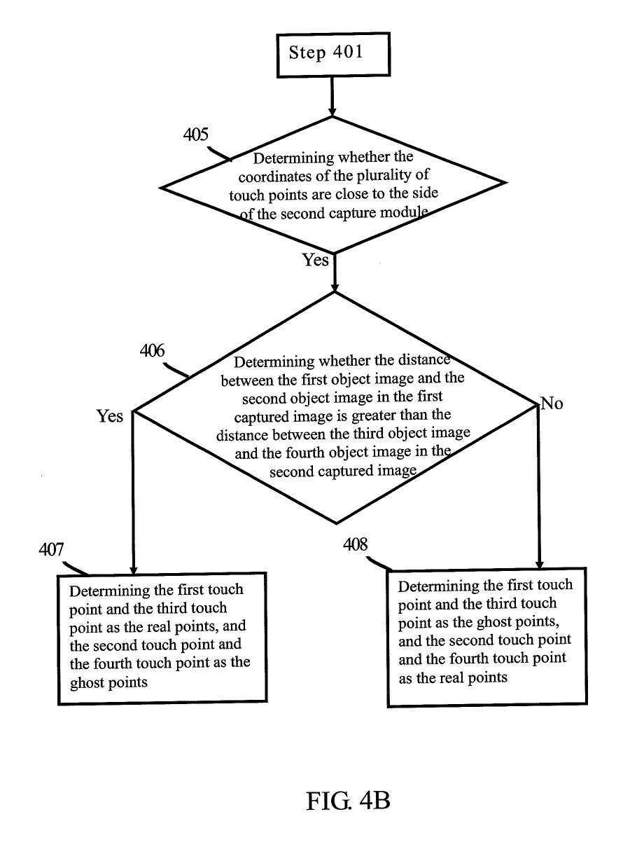

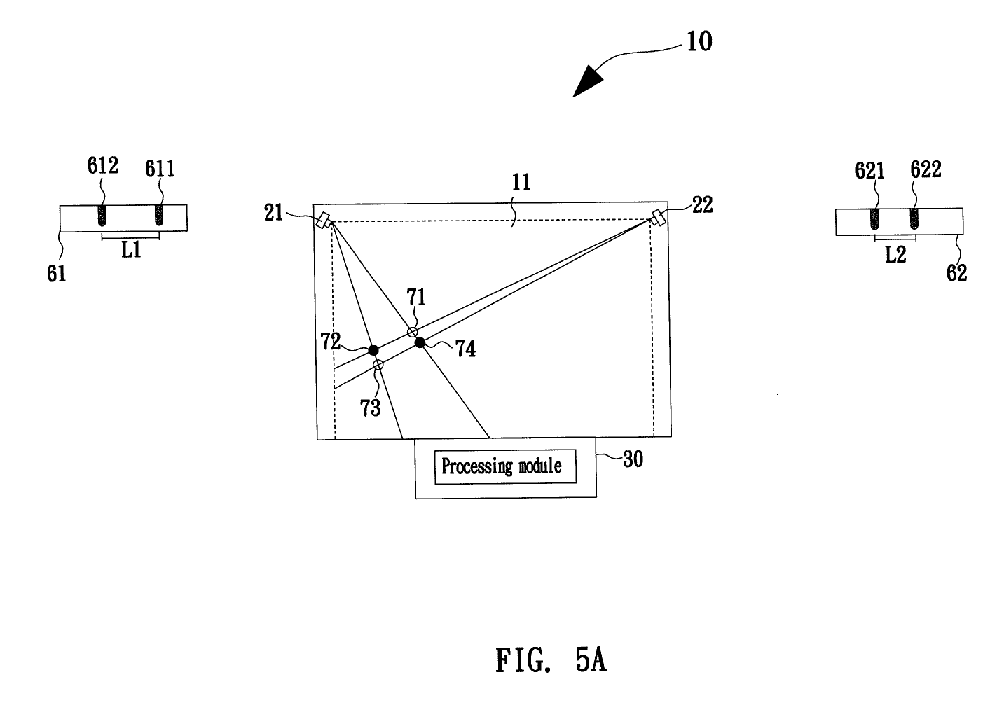

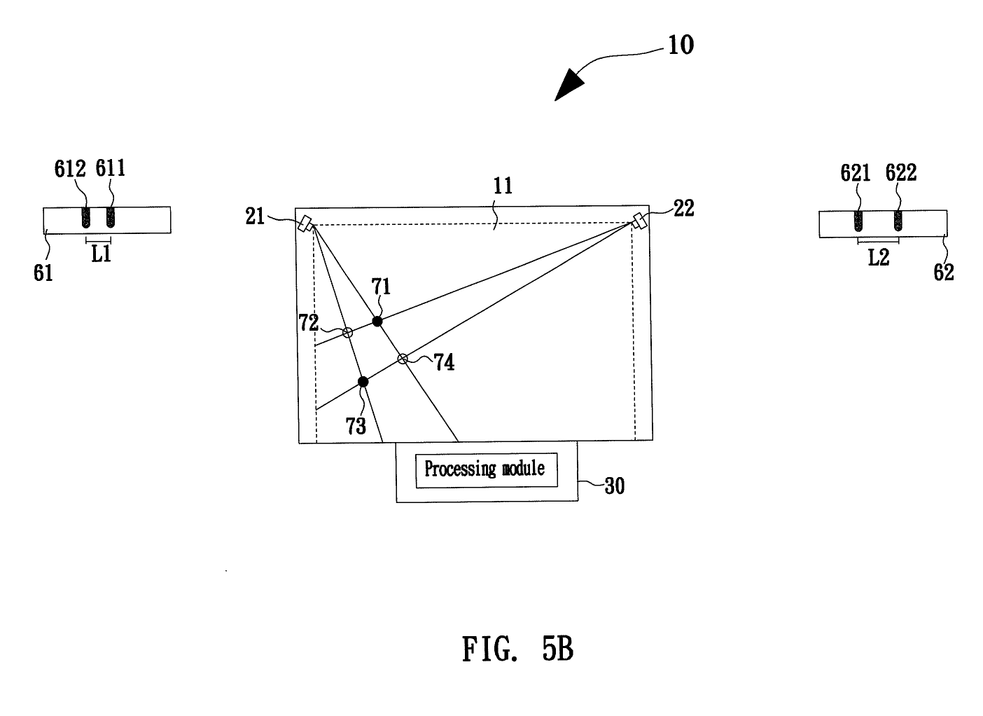

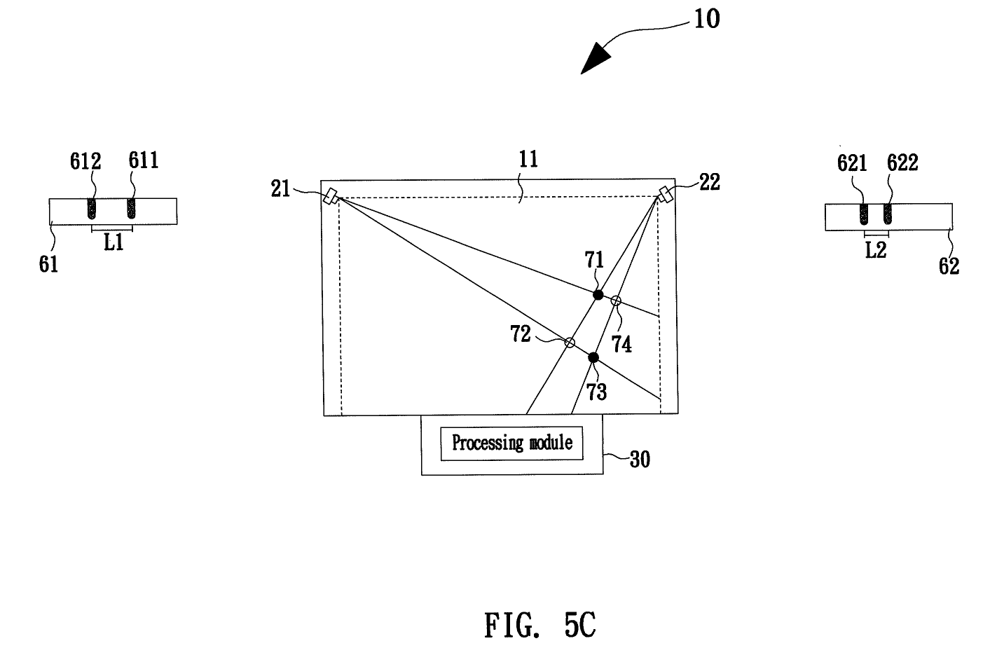

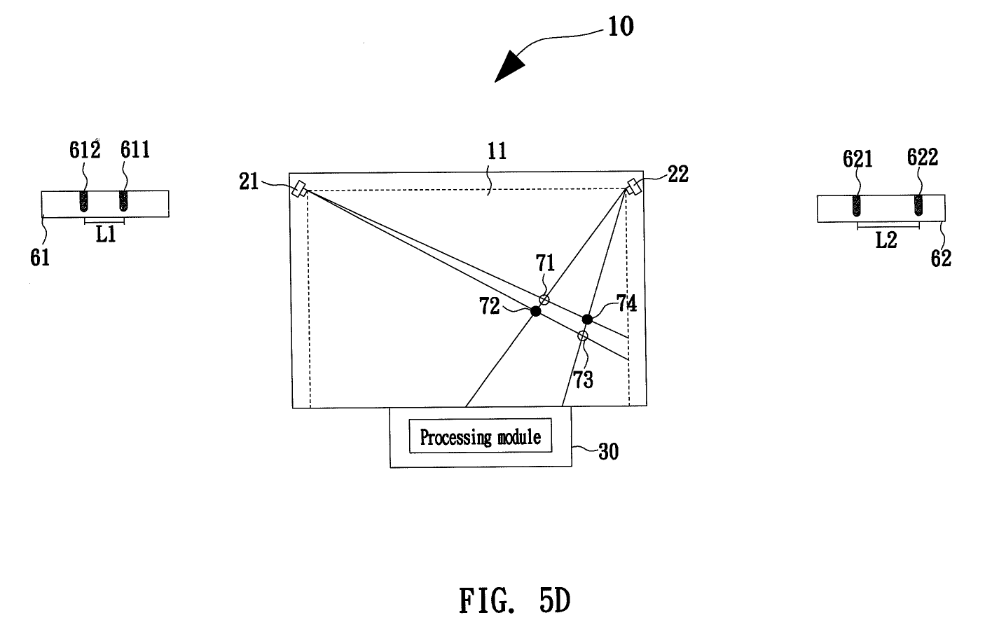

Then, please refer to FIGS. 4A-5D including schematic drawings related to a first embodiment of the present invention, wherein FIGS. 4A-4B illustrate flowcharts for determining whether a plurality of touch points are real points or ghost points according to the first embodiment of the present invention, and FIGS. 5A-5D illustrate schematic drawings of the optical touch device of the present invention in the first embodiment according to FIGS. 4A-4B.

In the first embodiment of the present invention, the positions of the real points or ghost points are calculated according to the distances among the first object image 611, the second object image 612, the third object image 621 and the fourth object image 622.

Firstly, the method performs step 401: determining whether the coordinates of the plurality of touch points are close to the side of the first capture module.

In step 303, the processing module 30 has already calculated the coordinates of the plurality of touch points. In step 401, the processing module 30 determines whether the plurality of touch points are all located close to the side of the first capture module 21; that is, the processing module 30 determines whether the plurality of touch points are all located in the lower-left side of the detection area 11.

If the plurality of touch points are all located in the lower-left side of the detection area 11, the method then performs step 402: determining whether the distance between the first object image and the second object image in the first captured image is greater than the distance between the third object image and the fourth object image in the second captured image.

The processing module 30 determines the relations between the distances L1 and L2, wherein the distance L1 refers to the distance between the first object image 611 and the second object image 612 in the first captured image 61, and the distance L2 refers to the distance between the third object image 621 and the fourth object image 622 in the second captured image 62. The processing module 30 utilizes the lengths of the distance L1 and the distance L2 to determine the positions of the real points.

If the distance L1 is greater than the distance L2, the method performs step 403: determining the first touch point and the third touch point as the ghost points, and the second touch point and the fourth touch point as the real points.

As shown in FIG. 5A, because the positions of the plurality of touch points are closer to the first capture module 21, with respect to the first capture module 21, the gentler the slope between two real points is, the more significant the length of the distance L1 is greater than the length of the distance L2. As a result, the processing module 30 can determine the second touch point 72 and the fourth touch point 74 with a gentler slope as the real points, and the remaining first touch point 71 and the third touch point 73 are definitely determined as the ghost points.

If the distance L1 is smaller than the distance L2, the method performs step 404: determining the first touch point and the third touch point as the real points, and the second touch point and the fourth touch point as the ghost points.

Oppositely, as shown in FIG. 5B, with respect to the first capture module 21, the steeper the slope between two real points is, the more significant the length of the distance L1 is smaller than the length of the distance L2. As a result, the processing module 30 can determine the first touch point 71 and the third touch point 73 with a steeper slope as the real points, and the remaining second touch point 72 and the fourth touch point 74 are definitely determined as the ghost points.

In step 401, if the processing module 30 determines that the coordinates of the plurality of touch points are not close to the side of the first capture module 21, the processing module 30 then performs step 405, so as to determine whether the coordinates of the plurality of touch points are close to the side of the second capture module 22. That is, the processing module 30 determines whether the plurality of touch points are all located in the lower-right side of the detection area 11.

If the plurality of touch points are all located in the lower-right side of the detection area 11, the method performs step 406: determining whether the distance between the first object image and the second object image in the first captured image is greater than the distance between the third object image and the fourth object image in the second captured image.

Similar to step 402, the processing module 30 also determines the relations between the distances L1 and L2, wherein the distance L1 refers to the distance between the first object image 611 and the second object image 612 in the first captured image 61, and the distance L2 refers to the distance between the third object image 621 and the fourth object image 622 in the second captured image 62.

If the distance L1 is greater than the distance L2, the method performs step 407: determining the first touch point and the third touch point as the real points, and the second touch point and the fourth touch point as the ghost points.

As shown in FIG. 5C, because the touch points are closer to the second capture module 22, with respect to the second capture module 22, the steeper the slope between two real points is, the more significant the length of the distance L2 is smaller than the length of the distance L1. As a result, the processing module 30 can determine the first touch point 71 and the third touch point 73 as the real points, and the remaining second touch point 72 and the fourth touch point 74 are definitely determined as the ghost points.

If the distance L2 is greater than the distance L1, the method performs step 408: determining the first touch point and the third touch point as the ghost points, and the second touch point and the fourth touch point as the real points.

Oppositely, as shown in FIG. 5D, with respect to the second capture module 22, the gentler the slope between the two real points is, the more significant the length of the distance L2 is greater than the length of the distance L1. As a result, the processing module 30 can determine the second touch point 72 and the fourth touch point 74 with a gentler slope as the real points, and the remaining third touch point 71 and the third touch point 73 are definitely determined as the ghost points.

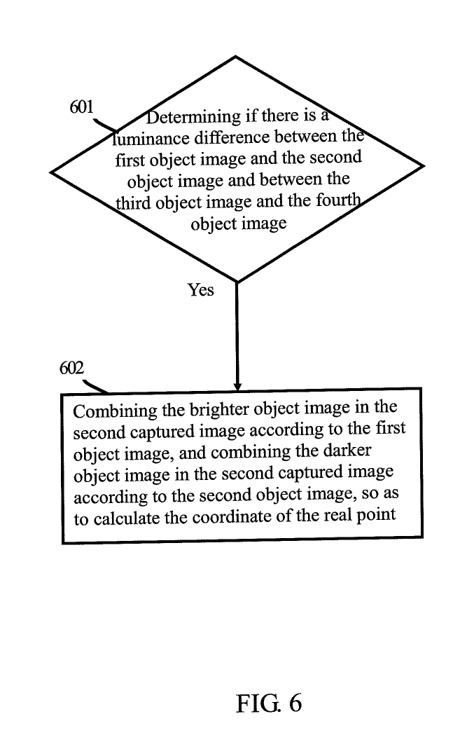

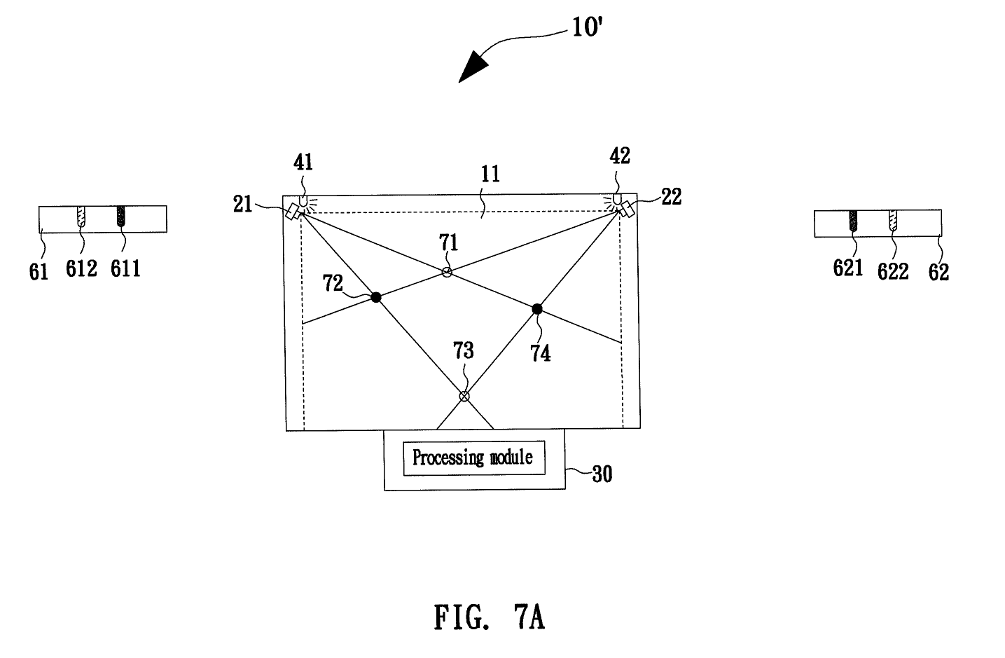

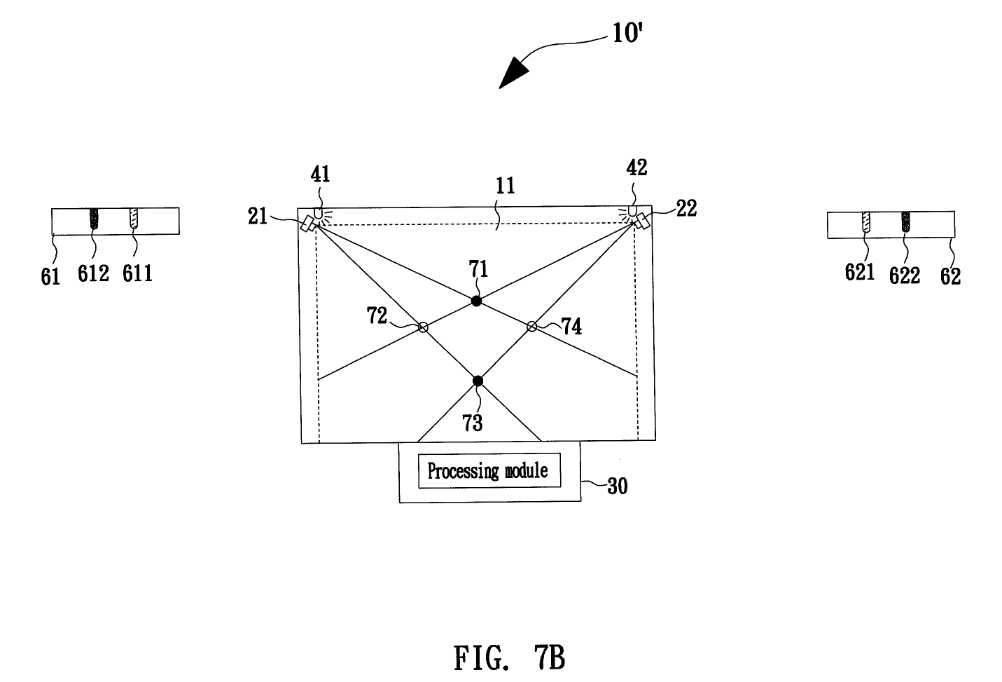

Then, please refer to FIGS. 6-7B including schematic drawings related to a second embodiment of the present invention, wherein FIG. 6 illustrates a flowchart for determining whether a plurality of touch points are real points or ghost points according to the second embodiment of the present invention, and FIGS. 7A-7B illustrate schematic drawings of the optical touch device of the present invention in the second embodiment according to FIG. 6.

In the second embodiment of the present invention, the optical touch device 10′ further comprises a first light emitting module 41 and a second light emitting module 42. The first light emitting module 41 is adjacent to the first capture module 21, and the second light emitting module 42 is adjacent to the second capture module 22, wherein both are used for providing light sources. According to the light sources emitted from the first light emitting module 41 and the second light emitting module 42, the first capture module 21 and the second capture module 22 can capture clearer and sharper images, and lights reflected by the objects having different distances would be significantly different.

Therefore, the second embodiment of the present invention firstly performs step 601: determining if there is a luminance difference between the first object image and the second object image and between the third object image and the fourth object image.

Take the first capture module 21 as a non-limiting example, if two real points have different distances from the first capture module 21, it is for sure that the first capture module 21 would capture object images with different luminance. Same situation applies to the second capture module 22. Therefore, in step 601, the processing module 30 firstly determines if there is a luminance difference between the first object image 611 and the second object image 612; meanwhile, the processing module 30 also determines if there is a luminance difference between the third object image 621 and the fourth object image 622.

If there is a luminance difference, the method performs step 602: combining the first object image with the brighter object image in the second captured image, and combining the second object image with the darker object image in the second captured image, so as to calculate the coordinate of the real point.

As shown in FIG. 7A, in the first captured image 61, if the luminance of the first object image 611 whose position is calculated earlier is darker than the luminance of the second object image 612 whose position is calculated later, it represents that the processing module 30 firstly calculates the position of the object farther from the first capture module 21, and then calculates the position of the object closer to the first capture module 21. Similarly, if the luminance of the third object image 621 whose position is calculated earlier is darker than the luminance of the fourth object image 622 whose position is calculated later, it represents that the processing module 30 firstly calculates the position of the object farther from the second capture module 22, and then calculates the position of the object closer to the second capture module 22.

Because all of the object images captured by the first capture module 21 and the second capture module 22 have significant luminance differences, and in this non-limiting example, the positions of both darker object images are calculated earlier, and the positions both brighter object images are calculated later, it is concluded that one object must be closer to the first capture module 21, and the other object must be closer to the second capture module 22. As a result, the object image (i.e. the first object image 611) in the first captured image 61 firstly calculated by the processing module 30 is associated with the brighter object image (i.e. the fourth object image 622) captured by the second capture module 22. Further, the object image (i.e. the second object image 612) in the first captured image 61 later calculated by the processing module 30 is associated with the darker object image (i.e. the third object image 621) captured by the second capture module 22.

Therefore, the processing module 30 calculates the position of the fourth touch point 74 according to the first captured angle θ1 of the first object image 611 and the fourth captured angle θ4 of the fourth object image 622, and calculates the position of the second touch point 72 according to the second captured angle θ2 of the second object image 612 and the third captured angle θ3 of the third object image 621. The positions of the second touch point 72 and the fourth touch point 74 are determined as the coordinates of the real points.

On the other hand, if all of the object images captured by the first capture module 21 and the second capture module 22 have significant luminance differences, and in this non-limiting example, the positions of both brighter object images are calculated earlier by the processing module 30, and the positions of both darker object images are calculated later by the processing module 30, it is concluded that the positions of the real points should be located in the center line of the detection area 11 as shown in FIG. 7B.

Therefore, the object image (i.e. the first object image 611) in the first captured image 61 firstly calculated by the processing module 30 is associated with the brighter object image (i.e. the third object image 621) captured by the second capture module 22. Further, the object image (i.e. the second object image 612) in the first captured image 61 later calculated by the processing module 30 is associated with the darker object image (i.e. the fourth object image 622) captured by the second capture module 22. Therefore, the processing module 30 calculates the position of the first touch point 71 according to the first captured angle θ1 of the first object image 611 and the third captured angle θ3 of the third object image 621, and calculates the position of the third touch point 73 according to the second captured angle θ2 of the second object image 612 and the fourth captured angle θ4 of the fourth object image 622. The positions of the first touch point 71 and the third touch point 73 are determined as the coordinates of the real points.

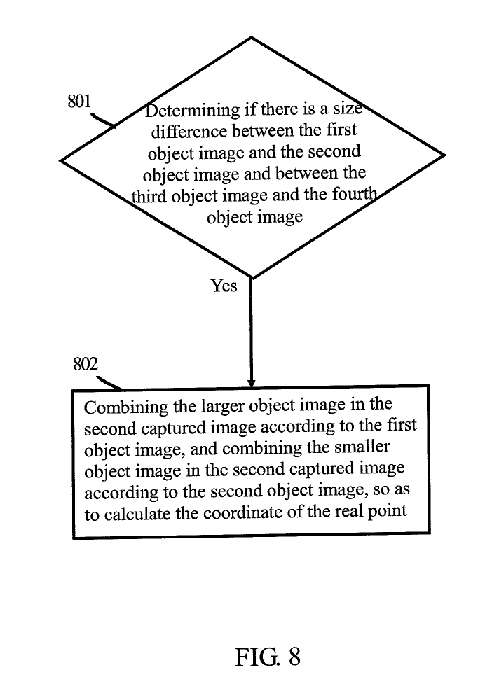

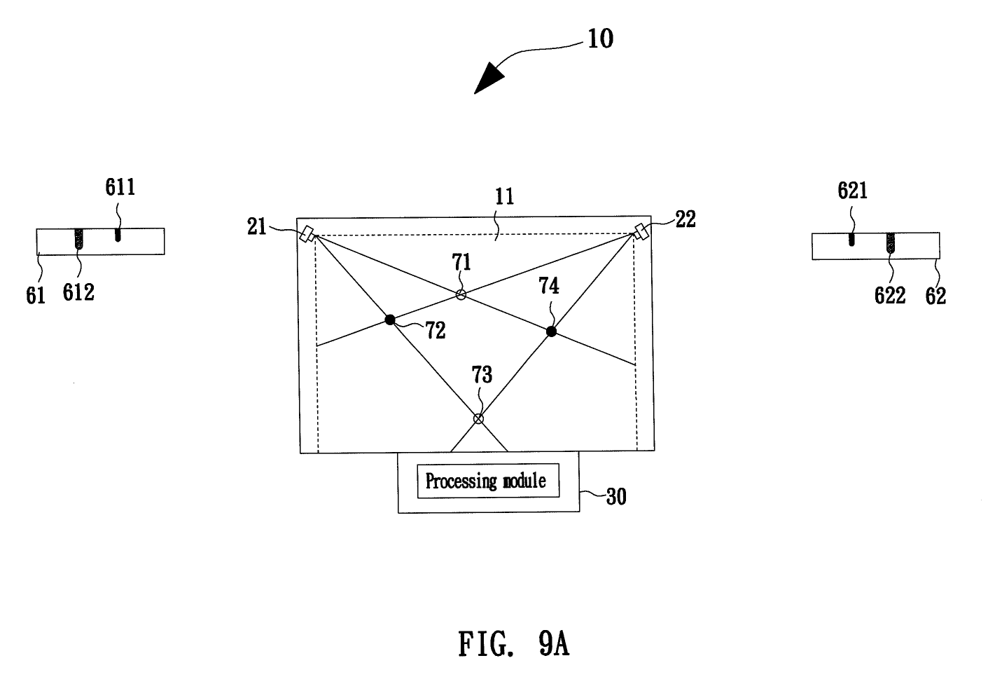

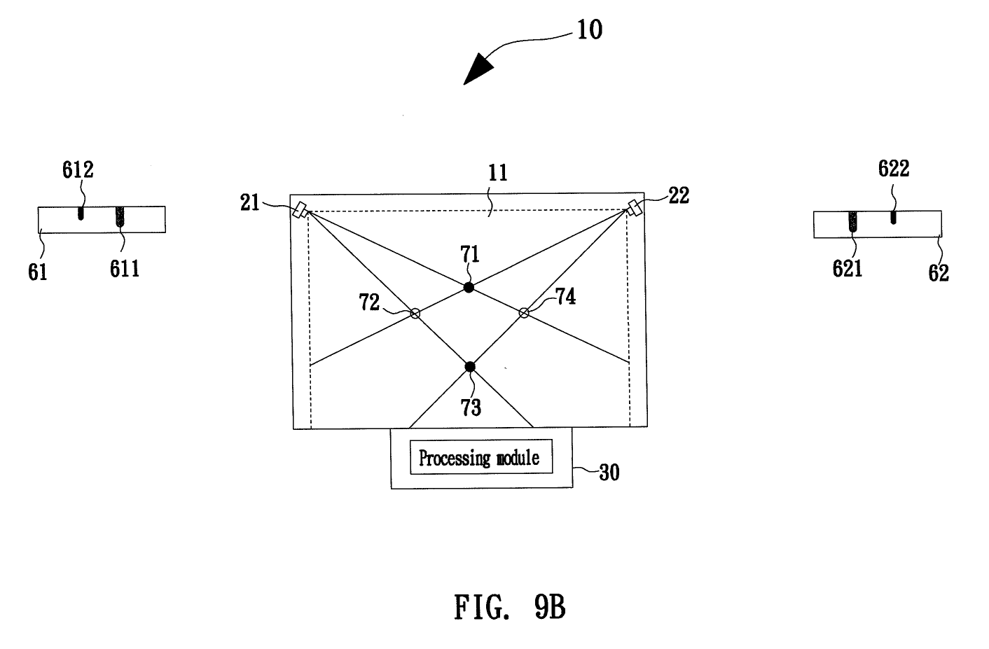

Then, please refer to FIGS. 8-9B including schematic drawings related to a third embodiment of the present invention, wherein FIG. 8 illustrates a flowchart for determining whether a plurality of touch points are real points or ghost points according to the third embodiment of the present invention, and FIGS. 9A-9B illustrate schematic drawings of the optical touch device of the present invention in the third embodiment according to FIG. 8.

In the third embodiment of the present invention, the method firstly performs step 801: determining if there is a size difference between the first object image and the second object image and between the third object image and the fourth object image.

Take the first capture module 21 as a non-limiting example, if the first object 51 and the second object 52 are similar objects, such as fingers or the same styluses, and the first object 51 and the second object 52 have different distances form the first capture module 21, it is for sure that the first capture module 21 would capture object images with different sizes. Same situation applies to the second capture module 22. Therefore, in step 801, the processing module 30 firstly determines if there is a size difference between the first object image 611 and the second object image 612; meanwhile, the processing module 30 also determines if there is a size difference between the third object image 621 and the fourth object image 622.

If there is a size difference, the method performs step 802: combining the first object image with the larger object image in the second captured image, and combining the second object image with the smaller object image in the second captured image, so as to calculate the coordinate of the real point.

As shown in FIG. 9A, in the first captured image 61, if the size of the first object image 611 whose position is calculated earlier is smaller than the size of the second object image 612 whose position is calculated later, it represents that the processing module 30 firstly calculates the position of the object farther from the first capture module 21, and then calculates the position of the object closer to the first capture module 21. Similarly, if the size of the third object image 621 whose position is calculated earlier is smaller than the size of the fourth object image 622 whose position is calculated later, it represents that the processing module 30 firstly calculates the position of the object farther from the second capture module 22, and then calculates the position of the object closer to the second capture module 22.

Because all of the object images captured by the first capture module 21 and the second capture module 22 have significant size differences, an in this non-limiting example, the positions of both smaller object images are calculated earlier, and the positions of both larger object images are calculated later, it is concluded that one object must be closer to the first capture module 21, and the other object must be closer to the second capture module 22. As a result, the object image (i.e. the first object image 611) in the first captured image 61 firstly calculated by the processing module 30 is associated with the larger object image (i.e. the fourth object image 622) captured by the second capture module 22. Further, the object image (i.e. the second object image 612) in the first captured image 61 later calculated by the processing module 30 is associated with the smaller object image (i.e. the third object image 621) captured by the second capture module 22.

Therefore, the processing module 30 calculates the position of the fourth touch point 74 according to the first captured angle θ1 of the first object image 611 and the fourth captured angle θ4 of the fourth object image 622, and calculates the position of the second touch point 72 according to the second captured angle θ2 of the second object image 612 and the third captured angle θ3 of the third object image 621. The positions of the second touch point 72 and the fourth touch point 74 are determined as the coordinates of the real points.

On the other hand, if all of the object images captured by the first capture module 21 and the second capture module 22 have significant size differences, and in this non-limiting example, the positions of both larger object images are calculated earlier by the processing module 30, and the positions of both smaller object images are calculated later by the processing module 30, it is concluded that the positions of the real points should be located in the center line of the detection area 11 as shown in FIG. 9B.

Therefore, the object image (i.e. the first object image 611) in the first captured image 61 firstly calculated by the processing module 30 is associated with the larger object image (i.e. the third object image 621) captured by the second capture module 22. Further, the object image (i.e. the second object image 612) in the first captured image 61 later calculated by the processing module 30 is associated with the smaller object image (i.e. the fourth object image 622) captured by the second capture module 22. Therefore, the processing module 30 calculates the position of the first touch point 71 according to the first captured angle θ1 of the first object image 611 and the third captured angle θ3 of the third object image 621, and calculates the position of the third touch point 73 according to the second captured angle θ2 of the second object image 612 and the fourth captured angle θ4 of the fourth object image 622. The positions of the first touch point 71 and the third touch point 73 are determined as the coordinates of the real points.

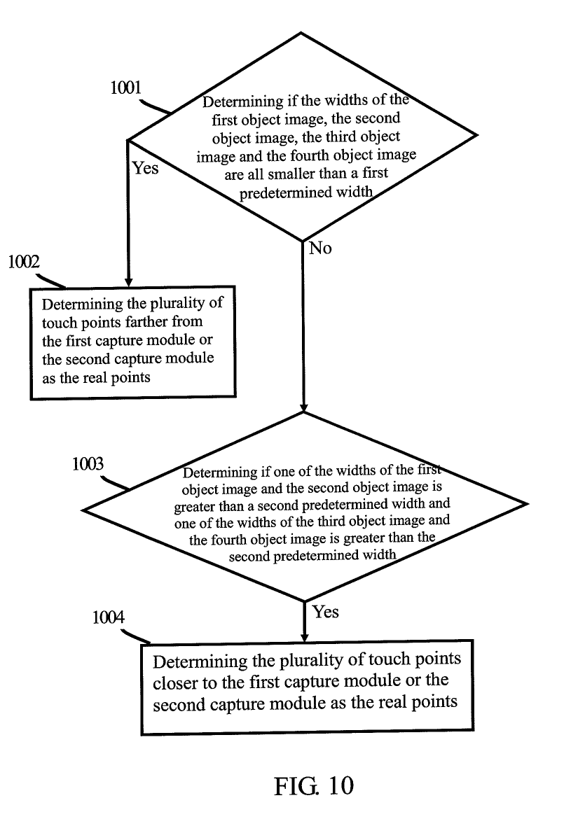

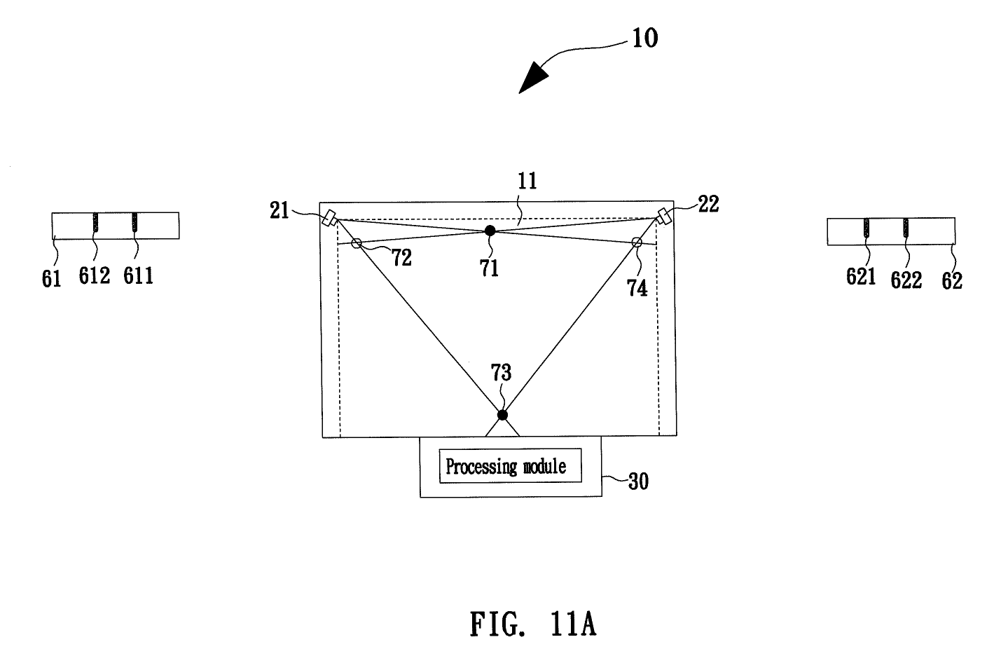

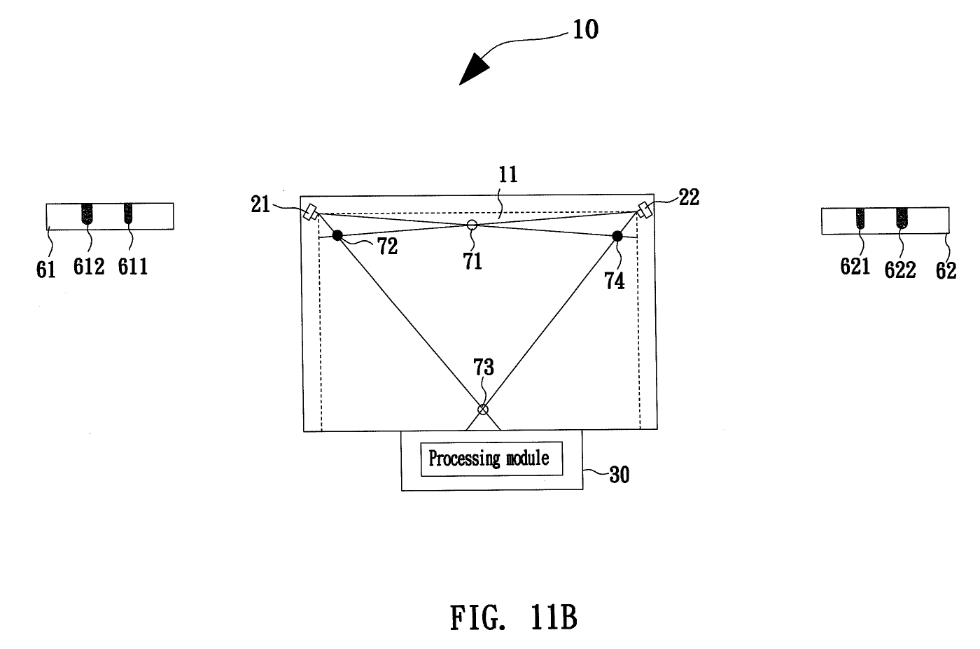

Then, please refer to FIGS. 10-11B including schematic drawings related to a fourth embodiment of the present invention, wherein illustrates a flowchart for determining whether a plurality of touch points are real points or ghost points according to the fourth embodiment of the present invention, and FIGS. 11A-11B illustrate schematic drawings of the optical touch device of the present invention in the fourth embodiment according to FIG. 10.

Firstly, the method performs step 1001: determining if the widths of the first object image, the second object image, the third object image and the fourth object image are all smaller than a first predetermined width.

In the fourth embodiment of the present invention, the processing module 30 determines if the widths of the first object image 611, the second object image 612, the third object image 621 and the fourth object image 622 are all smaller than the first predetermined width. This is similar to the concept of the third embodiment, that is, if the object is farther from the first capture module 21 and the second capture module 22, the size of the captured image must be smaller. The first predetermined width can be pre-assigned by a designer. For example, a width is measured according to an actual distance, and the first predetermined width is then stored in a memory module (not shown in figures) or an equivalent module; however, please note the scope of the present invention is not limited to the above description.

Therefore, if the widths of the first object image 611, the second object image 612, the third object image 621 and the fourth object image 622 are all smaller than the first predetermined width, the method performs step 1002: determining the plurality of touch points farther from the first capture module or the second capture module as the real points.

As shown in FIG. 11A, if the widths of the first object image 611, the second object image 612, the third object image 621 and the fourth object image 622 are all smaller than the first predetermined width, it represents that the real points are farther from the first capture module 21 and the second capture module 22, such as located in the center line of the detection area 11. Therefore, the processing module 30 determines the plurality of touch points farther from the first capture module 21 and the second capture module 22, i.e., the first touch point 71 and the third touch point 73 as shown in FIG. 11A, as the real points; and determines the second touch point 72 and the fourth touch point 74 closer to the first capture module 21 and the second capture module 22 as the ghost points.

If the widths of the first object image 611, the second object image 612, the third object image 621 and the fourth object image 622 are not all smaller than the first predetermined width, the method performs step 1003: determining if one of the widths of the first object image and the second object image is greater than a second predetermined width, and one of the widths of the third object image and the fourth object image is greater than the second predetermined width.

The processing module 30 determines if one of the widths of the first object image 611 and the second object image 612 is greater than the second predetermined width; meanwhile, the processing module 30 determines if one of the widths of the third object image 621 and the fourth object image 622 is greater than the second predetermined width.

By means of determining if the one of the widths of the third object image 621 and the fourth object image 622 is greater than the second predetermined width, the present invention can determine whether the positions of the real points are closer to the first capture module 21 or the second capture module 22. Similar to the first predetermined width, the second predetermined width can be, but not limited to, pre-assigned by the designer.

If one of the widths of the first object image 611 and the second object image 612 is greater than the second predetermined width, and one of the widths of the third object image 621 and the fourth object image 622 is greater than the second predetermined width, the method performs step 1004: determining the plurality of touch points closer to the first capture module or the second capture module as the real points.

If one of the widths of the first object image 611 and the second object image 612 is greater than the second predetermined width, such as the second object image 612 as shown in FIG. 11B, the processing module 30 determines the touch point closest to the first capture module 21, i.e., the second touch point 72, as the real point. Similarly, if one of the widths of the third object image 621 and the fourth object image 622 is greater than the second predetermined width, the processing module 30 determines the fourth touch point 74 closest to the second capture module 22 as the real point. As a result, the first touch point 71 and the third touch point 73 must be the ghost points.

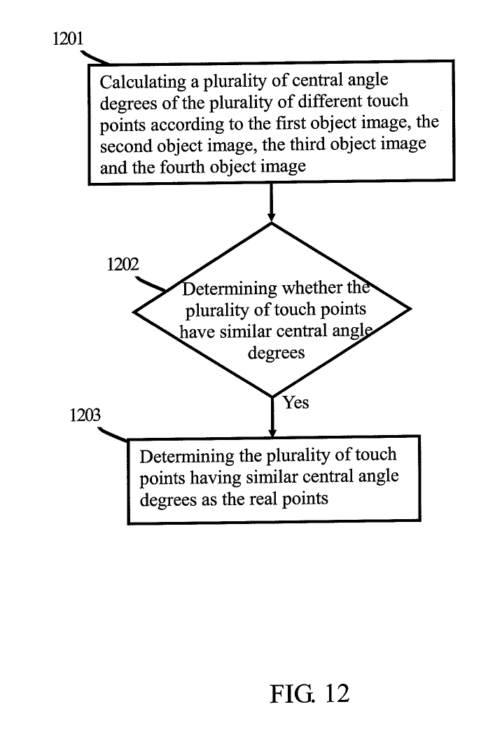

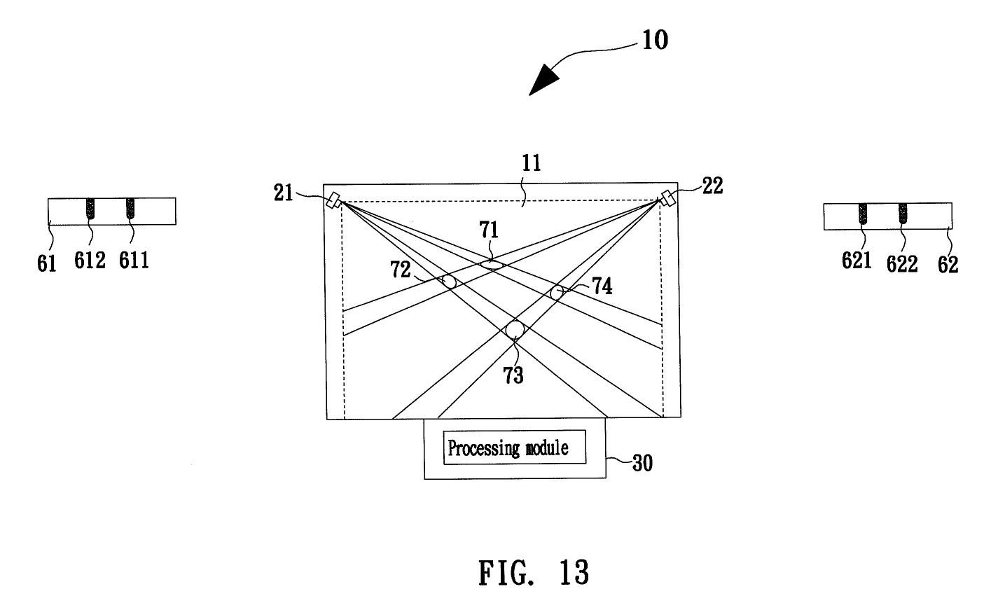

Next, please refer to FIGS. 12-13 including schematic drawings related to a fifth embodiment of the present invention, wherein FIG. 12 illustrates a flowchart for determining whether a plurality of touch points are real points or ghost points according to the fifth embodiment of the present invention, and FIG. 13 illustrates a schematic drawing of the optical touch device of the present invention in the fifth embodiment according to FIG. 12.

Firstly, the method performs step 1201: calculating a plurality of central angle degrees of the plurality of different touch points according to the first object image, the second object image, the third object image and the fourth object image.

In the fifth embodiment of the present invention, the processing module 30 firstly calculates the plurality of central angle degrees of the plurality of different touch points. Practically, different touch points of the objects on the detection area 11 can form different touch areas. Further, if the first object 51 and the second object 52 are similar objects, the real touch areas should have similar characteristics, which should be different from the characteristics of the ghost touch areas. As shown in FIG. 13, because the object images captured by the first capture module 21 and the second capture module 22 have their own widths which represent different captured angles, the processing module 30 can obtain the characteristics of different touch areas according to different captured angle. In step 1201, the plurality of central angle degrees of different touch points are calculated for further comparison.

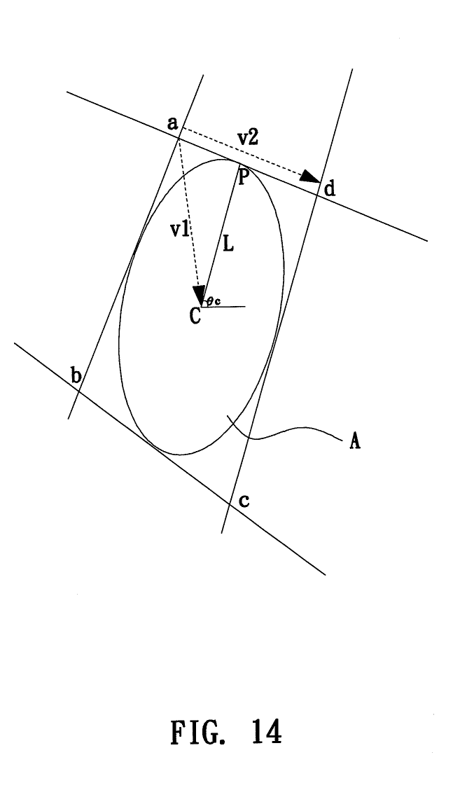

With regard to the method of calculating the central angle degree, please refer to FIG. 14 which illustrates a schematic drawing showing the optical touch device calculates a central angle degree according to the present invention.

Take FIG. 14 as a non-limiting example, when the processing module 30 needs to calculate the central angle degree θc of the touch area A, at first, coordinates of intersection points a, b, c and d would be calculated according to different captured angles. As a result, the coordinate of the center C can be calculated according to the following equation:

$$C = \frac{a + b + c + d}{4} .$$

Then, the processing module 30 calculates a vector v1 from the intersection point a to the center C, and a vector v2 from the intersection point a to the intersection point d, then performs a cross product to the vector v1 and the vector v2, and divides the result of the vector product by the distance between the intersection point a and the intersection point b. As a result, a longest radius L can be calculated according to the following equation:

$$L = \frac{cross ( v 1 , v 2 )}{ad} .$$

After obtaining the longest radius L, the processing module 30 obtains the coordinate of an intersection point P between the intersection point a and the intersection point d in the touch area A. Finally, the processing module 30 can calculate the central angle degree θc according to the following equation:

$$θ c = \frac{a tan ( P ) * 180}{π} .$$

Because the method of calculating the central angle degree θc has been widely known by those skilled in the art, there is no need for further description.

After obtaining the central angle degree θc, the method performs step 1202: determining whether the plurality of touch points have similar central angle degrees.

The processing module 30 retrieves the absolute values of the calculated central angle degrees of the first touch point 71, the second touch point 72, the third touch point 73 and the fourth touch point 74, and then compares whether there are similar values.

For the first touch point 71, the second touch point 72, the third touch point 73 and the fourth touch point 74, if two central angle degrees have similar absolute values, the method performs step 1203: determining the plurality of touch points having similar central angle degrees as the real points.

If the central angle degree of the first touch point 71 is 0 degree, the central angle degree of the second touch point 72 is 35 degrees, the central angle degree of the third touch point 73 is −45 degrees, and the central angle degree of the fourth touch point 74 is −35 degrees, the processing module 30 determines the second touch point 72 and the fourth touch point 74 having similar absolute values of the central angle degrees as the real points, and determines the first touch point 71 and the third touch point 73 as the ghost points.

Please note that the coordinate detection method of the present invention is not limited to the abovementioned step orders. As long as the object of the present invention can be achieved, the step orders can be adjusted accordingly.

Therefore, the present invention can utilize one of the abovementioned first to fifth embodiments to determine the positions of the real points. Or, the present invention can sequentially execute the first to fifth embodiments. For example, if the first embodiment fails to determine the positions of the real points, the invention can then execute the second embodiment, and so on, so as to achieve the optimal determination effect.

Although the present invention has been explained in relation to its preferred embodiments, it is to be understood that many other possible modifications and variations can be made without departing from the spirit and scope of the invention as hereinafter claimed.

1. An optical touch device, comprising:
a detection area, used for allowing a first object and a second object to contact with;
a first capture module, for capturing a first captured image from the detection area to capture a first object image and a second object image;
a second capture module, for capturing a second captured image from the detection area to capture a third object image and a fourth object image; and
a processing module, electrically connected to the first capture module and the second capture module, the processing module calculating coordinates of a plurality of touch points according to the first captured image and the second captured image, and determining whether each of the plurality of touch points is a real point or a ghost point according to the relations among the first object image, the second object image, the third object image and the fourth object image.

2. The optical touch device as claimed in claim 1, wherein the first capture module and the second capture module are respectively disposed to adjacent corners of the detection area.

3. The optical touch device as claimed in claim 2, wherein:
the processing module performs calculation in the first captured image from a side close to a horizontal axis toward a side close to a vertical axis of the detection area, so as to sequentially calculate a first captured angle of the first object image and a second captured angle of the second object image; and
the processing module performs calculation in the second captured image from the side close to the horizontal axis toward the side close to the vertical axis of the detection area, so as to sequentially calculate a third captured angle of the third object image and a fourth captured angle of the fourth object image.

4. The optical touch device as claimed in claim 3, wherein the plurality of touch points comprise a first touch point, a second touch point, a third touch point and a fourth touch point, wherein:
the coordinate of the first touch point is calculated according to the first captured angle of the first object image and the third captured angle of the third object image;
the coordinate of the second touch point is calculated according to the second captured angle of the second object image and the third captured angle of the third object image;
the coordinate of the third touch point is calculated according to the second captured angle of the second object image and the fourth captured angle of the fourth object image; and
the coordinate of the fourth touch point is calculated according to the first captured angle of the first object image and the fourth captured angle of the fourth object image;
wherein if the coordinate of any of the touch points exceeds the range of the detection area, the processing module determines the touch point and its paired touch point as the ghost points.

5. The optical touch device as claimed in claim 4, wherein:
when the coordinates of the plurality of touch points are close to the side of the first capture module, the processing module determines whether a distance between the first object image and the second object image in the first captured image is greater than a distance between the third object image and the fourth object image in the second captured image;
if yes, the processing module determines the first touch point and the third touch point as the ghost points, and the second touch point and the fourth touch point as the real points; and
if no, the processing module determines the first touch point and the third touch point as the real points, and the second touch point and the fourth touch point as the ghost points.

6. The optical touch device as claimed in claim 5, wherein:
when the coordinates of the plurality of touch points are close to the side of the second capture module, the processing module determines whether the distance between the first object image and the second object image in the first captured image is greater than the distance between the third object image and the fourth object image in the second captured image;
if yes, the processing module determines the first touch point and the third touch point as the real points, and the second touch point and the fourth touch point as the ghost points; and
if no, the processing module determines the first touch point and the third touch point as the ghost points, and the second touch point and the fourth touch point as the real points.

7. The optical touch device as claimed in claim 3, further comprising:
a first light emitting module, adjacent to the first capture module; and
a second light emitting module, adjacent to the second capture module;
wherein the first light emitting module and the second light emitting module respectively provide a light source to the first capture module and the second capture module.

8. The optical touch device as claimed in claim 7, wherein if there is a luminance difference between the first object image and the second object image and between the third object image and the fourth object image, the processing module combines the first object image with the brighter object image in the second captured image, and combines the second object image with the darker object image in the second captured image, so as to calculate the coordinate of the real point.

9. The optical touch device as claimed in claim 3, wherein if there is a size difference between the first object image and the second object image and between the third object image and the fourth object image, the processing module combines the first object image with the larger object image in the second captured image, and combines the second object image with the smaller object image in the second captured image, so as to calculate the coordinate of the real point.

10. The optical touch device as claimed in claim 3, wherein if the widths of the first object image, the second object image, the third object image and the fourth object image are all smaller than a first predetermined width, the processing module determines the plurality of touch points farther from the first capture module or the second capture module as the real points.

11. The optical touch device as claimed in claim 10, wherein if one of the widths of the first object image and the second object image is greater than a second predetermined width, and one of the widths of the third object image and the fourth object image is greater than the second predetermined width, the processing module determines the plurality of touch points closer to the first capture module or the second capture module as the real points.

12. The optical touch device as claimed in claim 1, wherein the processing module calculates a plurality of central angle degrees of the plurality of different touch points according to the first object image, the second object image, the third object image and the fourth object image, and determines whether the plurality of touch points have similar central angle degrees; if yes, the processing module determines the plurality of touch points having similar central angle degrees as the real points.

13. The optical touch device as claimed in claim 12, wherein the processing module calculates the plurality of central angle degrees according to a center coordinate and a longest radius of each of the plurality of different touch points.

14. A coordinate detection method, used in an optical touch device, the optical touch device comprising a detection area used for allowing a first object and a second object to contact with, the method comprising the following steps:
capturing a first captured image from the detection area to capture a first object image and a second object image according to a first capture module;
capturing a second captured image from the detection area to capture a third object image and a fourth object image according to a second capture module;
calculating coordinates of a plurality of touch points according to the first captured image and the second captured image; and
determining whether each of the plurality of touch points is a real point or a ghost point according to the relations among the first object image, the second object image, the third object image and the fourth object image.

15. The coordinate detection method as claimed in claim 14, further comprising the following steps:
performing calculation in the first captured image from a side close to a horizontal axis toward a side close to a vertical axis of the detection area, so as to sequentially calculate a first captured angle of the first object image and a second captured angle of the second object image; and
performing calculation in the second captured image from the side close to the horizontal axis toward the side close to the vertical axis of the detection area, so as to sequentially calculate a third captured angle of the third object image and a fourth captured angle of the fourth object image.

16. The coordinate detection method as claimed in claim 15, wherein the plurality of touch points comprise a first touch point, a second touch point, a third touch point and a fourth touch point, and the step of calculating the coordinates of the plurality of touch points further comprises:
calculating the coordinate of the first touch point according to the first captured angle of the first object image and the third captured angle of the third object image;
calculating the coordinate of the second touch point according to the second captured angle of the second object image and the third captured angle of the third object image;
calculating the coordinate of the third touch point according to the second captured angle of the second object image and the fourth captured angle of the fourth object image; and
calculating the coordinate of the fourth touch point according to the first captured angle of the first object image and the fourth captured angle of the fourth object image;
wherein if the coordinate of any of the touch points exceeds the range of the detection area, the touch point and its paired touch point are determined as the ghost points.

17. The coordinate detection method as claimed in claim 16, wherein the step of determining whether each of the plurality of touch points is the real point or the ghost point further comprises:
when the coordinates of the plurality of touch points are close to the side of the first capture module, determining whether a distance between the first object image and the second object image in the first captured image is greater than a distance between the third object image and the fourth object image in the second captured image;
if yes, determining the first touch point and the third touch point as the ghost points, and the second touch point and the fourth touch point as the real points; and
if no, determining the first touch point and the third touch point as the real points, and the second touch point and the fourth touch point as the ghost points.

18. The coordinate detection method as claimed in claim 17, wherein the step of determining whether each of the plurality of touch points is the real point or the ghost point further comprises:
when the coordinates of the plurality of touch points are close to the side of the second capture module, determining whether the distance between the first object image and the second object image in the first captured image is greater than the distance between the third object image and the fourth object image in the second captured image;
if yes, determining the first touch point and the third touch point as the real points, and the second touch point and the fourth touch point as the ghost points; and
if no, determining the first touch point and the third touch point as the ghost points, and the second touch point and the fourth touch point as the real points.

19. The coordinate detection method as claimed in claim 15, wherein the step of determining whether each of the plurality of touch points is the real point or the ghost point further comprises:
if there is a luminance difference between the first object image and the second object image and between the third object image and the fourth object image, combining the first object image with the brighter object image in the second captured image, and combining the second object image with the darker object image in the second captured image, so as to calculate the coordinate of the real point.

20. The coordinate detection method as claimed in claim 15, wherein the step of determining whether each of the plurality of touch points is the real point or the ghost point further comprises:
if there is a size difference between the first object image and the second object image and between the third object image and the fourth object image, combining the first object image with the larger object image in the second captured image, and combining the second object image with the smaller object image in the second captured image, so as to calculate the coordinate of the real point.

21. The coordinate detection method as claimed in claim 15, wherein the step of determining whether each of the plurality of touch points is the real point or the ghost point further comprises:
if the widths of the first object image, the second object image, the third object image and the fourth object image are all smaller than a first predetermined width, determining the plurality of touch points farther from the first capture module or the second capture module as the real points.

22. The coordinate detection method as claimed in claim 21, wherein the step of determining whether each of the plurality of touch points is the real point or the ghost point further comprises:
if one of the widths of the first object image and the second object image is greater than a second predetermined width, and one of the widths of the third object image and the fourth object image is greater than the second predetermined width, determining the plurality of touch points closer to the first capture module or the second capture module as the real points.

23. The coordinate detection method as claimed in claim 14, wherein the step of determining whether each of the plurality of touch points is the real point or the ghost point further comprises:
calculating a plurality of central angle degrees of the plurality of different touch points according to the first object image, the second object image, the third object image and the fourth object image;
determining whether the plurality of touch points have similar central angle degrees; and
if yes, determining the plurality of touch points having similar central angle degrees as the real points.

24. The coordinate detection method as claimed in claim 23, wherein the step of determining whether the plurality of touch points has similar central angle degrees comprises:
comparing absolute values of the plurality of central angle degrees.

25. The coordinate detection method as claimed in claim 23, wherein the step of calculating the plurality of central angle degrees comprises:
calculating the plurality of central angle degrees according to a center coordinate and a longest radius of each of the plurality of different touch points.
